(19) United States
(12) Patent Application Publication
(10) Pub. No.: US 2013/0094179 A1
(43) Pub. Date: Apr. 18, 2013

(54) SOLID-STATE LIGHT EMITTING DEVICES WITH MULTIPLE REMOTE WAVELENGTH CONVERSION COMPONENTS

(71) Applicants: Bing Dai, Fremont, CA (US); Charles Edwards, Pleasanton, CA (US)

(72) Inventors: Bing Dai, Fremont, CA (US); Charles Edwards, Pleasanton, CA (US)

(73) Assignee: INTEMATIX CORPORATION, Fremont, CA (US)

(21) Appl. No.: 13/273,205

(22) Filed: Oct. 13, 2011

(51) Int. Cl. F21K 2/00

(52) U.S. Cl. 362/84

(57) ABSTRACT

A light emitting device comprises a solid-state light source; a first wavelength conversion component comprising a first photo-luminescent material and a second wavelength conversion component comprising a second photo-luminescent material. At least the second wavelength conversion component is remote to the solid state light source and the first wavelength conversion component is closer in proximity to the solid-state light source and smaller in area than the second wavelength conversion component.

### FIELD

This disclosure relates to solid-state light emitting devices that utilize remote wavelength conversion to generate a selected color of light.

### BACKGROUND

White light emitting LEDs (“white LEDs”) are known and are a relatively recent innovation. It was not until LEDs emitting in the blue/ultraviolet part of the electromagnetic spectrum were developed that it became practical to develop white light sources based on LEDs. White LEDs include photo-luminescent materials (e.g., one or more phosphor materials), which absorb a portion of the radiation emitted by the LED and re-emit light of a different color (wavelength). Typically, the LED chip or die generates blue light and the phosphor(s) then absorbs a percentage of the blue light emitted by the LED chip to re-emit yellow light or a combination of green and red light, green and yellow light, green and orange or yellow and red light. The portion of the blue light generated by the LED that is not absorbed by the phosphor material combined with the light emitted by the phosphor provides light to an observer which appears to the eye as being nearly white in color. The phosphor material(s) are normally mixed with a light transmissive material such as a silicone and the mixture applied directly to the light emitting surface(s) of the LED die.

It is also known to include the phosphor material in a wavelength conversion component that is located remotely to the LED, a so called “remote phosphor” arrangement. Advantages of remote phosphor arrangements include a reduced likelihood of thermal degradation of the phosphor material and a more consistent color of generated light.

An example of a white light emitting device that utilizes a remote wavelength conversion component will now be described with reference to FIG. 1 which shows a schematic partial cutaway plan and sectional views of the device. The device 100 comprises a housing 101 with a base 103 and sidewall 105. The device 100 further comprises a plurality of blue light emitting LEDs (blue LEDs) 107 that are mounted to the base 103 of the device 100. The LEDs 107 may be configured in various arrangements.

The device 100 includes a wavelength conversion component 109 that is positioned remotely to the LEDs 107. The term “remotely” and “remote” refers to a spaced or separated relationship. The wavelength conversion component 109 typically comprises a light transmissive substrate 111 and a wavelength conversion layer 113 in contact with the light transmissive substrate 111. As illustrated in FIG. 1 the wavelength conversion component 109 may be configured such that the wavelength conversion layer 113 is facing the LEDs 107.

The wavelength conversion layer 113 comprises a photo-luminescent material, such as for example a phosphor material. The wavelength conversion layer 113 of the wavelength conversion component 109, and particularly the phosphor material, absorbs a proportion of the blue light generated by the LEDs 107 and converts it to light of a different wavelength by a process of photoluminescence. A proportion of the blue light generated by the LEDs 107 is not converted to light of a different wavelength, but instead is transmitted through the wavelength conversion component 109. The final emission product of the light emitting device 100, which is typically white, is thus a combination of the light generated by the LEDs 107 and light generated by the wavelength conversion layer 113 (e.g. light converted to a different wavelength by a process of photoluminescence).

A problem with existing light emitting devices using a remote wavelength conversion component is the high cost of certain phosphor materials. For example, depending on material composition, the cost of red phosphor can be more than 100 times greater than the cost of yellow or green phosphors. Typically, to achieve emission products with a warm color temperature (e.g., 4000K and greater) the use of red phosphors are necessary. Additionally, in order for a light emitting device to generate white light with a high CRI (e.g. 85 or greater) it is necessary for the final emission product to include a red light component and this may be generated by such phosphor materials. Moreover, compared with devices in which the phosphor encapsulates the LED die in a remote wavelength conversion component, a remote phosphor device as shown in FIG. 1 requires the phosphor material to be provided over a much larger area, necessarily requiring a larger quantity of phosphor and further increasing manufacturing costs.

Whilst remote wavelength conversion components offer a number of benefits, a customer criticism is the aesthetic appearance of the wavelength conversion component in an “off-state” which is typically yellow due to the phosphor material. This undesirable visual appearance is further compounded in high CRI wavelength conversion components containing red light emitting phosphor materials since their appearance in an off-state can be orange.

The present invention arose in an endeavor to, at least in part, overcome the limitations and problems of solid-state light emitting devices that utilize a remote wavelength conversion component.

### BRIEF DESCRIPTION OF THE DRAWINGS

In order that the present invention is better understood light emitting devices and wavelength conversion components in accordance with the invention will now be described, by way of example only, with reference to the accompanying drawings in which like reference numerals are used to denote like parts, and in which:

FIG. 1 illustrate san example LED lighting device.

FIG. 2A illustrates a cross-sectional view of a light emitting device according to some embodiments.

FIG. 2B illustrates a cross-sectional of a light emitting device in accordance with some embodiments.

FIG. 3A illustrates a cross-sectional view of a light emitting device in accordance with some embodiments.

FIG. 3B illustrates a cross-sectional of a light emitting device in accordance with some embodiments.

FIG. 4A illustrates a cross-sectional view of a light emitting device in accordance with some embodiments.

FIG. 4B illustrates a cross-sectional of a light emitting device in accordance with some embodiments.

FIG. 5 illustrates a cross-sectional of a light emitting device in accordance with some embodiments.

FIG. 6A illustrates the light emitting device of FIG. 2A with an additional diffusing layer.

FIG. 6B illustrates a three-dimensional configuration of the light emitting device of FIG. 6A.

FIGS. 7A, 7B, and 7C illustrate an example of an application of a wavelength conversion component in accordance with some embodiments.

FIGS. 8A, 8B, and 8C illustrate another example of an application of a wavelength conversion component in accordance with some embodiments.

FIG. 9 illustrates another example of an application of a wavelength conversion component in accordance with some embodiments.

FIGS. 10A and 10B illustrate another example of an application of a wavelength conversion component in accordance with some embodiments.

FIGS. 11A and 11B illustrate a perspective view and a cross-sectional view of an application of a wavelength conversion component in accordance with some embodiments.

FIG. 12 illustrates a perspective of another application of a wavelength conversion component in accordance with some embodiments.

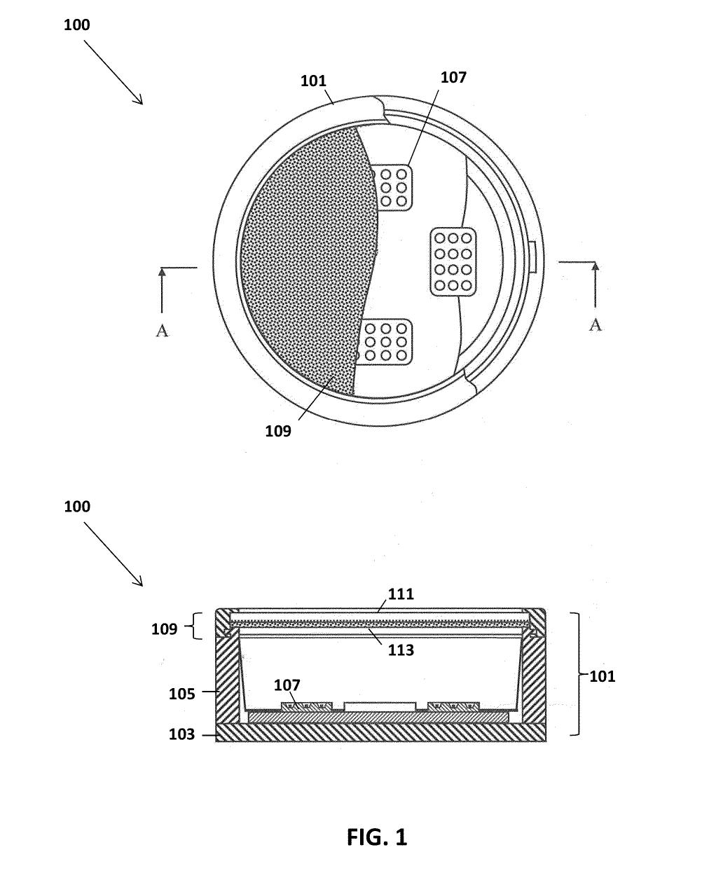

### SUMMARY OF THE INVENTION

Embodiments of the invention concern solid-state light emitting devices that utilize one or more wavelength conversion components and multiple photo-luminescent materials. In some embodiments, a light emitting device includes a solid-state light source, a first wavelength conversion component comprising a first photo-luminescent material, and a second wavelength conversion component comprising a second photo-luminescent material, wherein the first wavelength conversion component is closer in proximity to the solid-state light source and smaller in area than the second wavelength conversion component. In some embodiments the first and second wavelength conversion components are remote to the light source. In other embodiments it is envisioned to incorporate the first photo-luminescent material with the solid-state light source. Typically the first photo-luminescent material includes a red light emitting phosphor whilst the second photo-luminescent material comprises yellow and/or green light emitting phosphor materials.

Further details of aspects, objects, and advantages of the invention are described below in the detailed description, drawings, and claims. Both the foregoing general description and the following detailed description are exemplary and explanatory, and are not intended to be limiting as to the scope of the invention.

### DETAILED DESCRIPTION

Various embodiments are described hereinafter with reference to the figures. It should be noted that the figures are not necessarily drawn to scale. It should also be further noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments” in various places throughout this specification are not necessarily referring to the same embodiment or embodiments.

For the purposes of illustration only, the following description is made with reference to photo-luminescent material embodied specifically as phosphor materials. However, the invention is applicable to any type of photo-luminescent material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths. As such, the invention is not limited to phosphor based wavelength conversion components unless claimed as such.

Embodiments of the invention concern solid-state light emitting devices that utilize multiple wavelength conversion components, in which different types of phosphors are placed into the different wavelength conversion components. The different wavelength conversion components correspond to different relative positions to an LED light source, e.g., where a first wavelength conversion component is closer in proximity to the LED light source and the second wavelength conversion component is farther from the LED light source. Since the first wavelength conversion component is closer than the second wavelength conversion component to the LED light source, the first wavelength conversion component correspondingly requires a smaller area and/or size as compared to the second wavelength conversion component. As a result, less phosphor material is required to manufacture the wavelength conversion component that is closer in proximity to the LED light source. Therefore, manufacturing costs can be significantly reduced by placing the more expensive red phosphor materials into the wavelength conversion component that is closer in proximity to the LED light source, and placing the less expensive phosphor materials into the more distant wavelength conversion component.

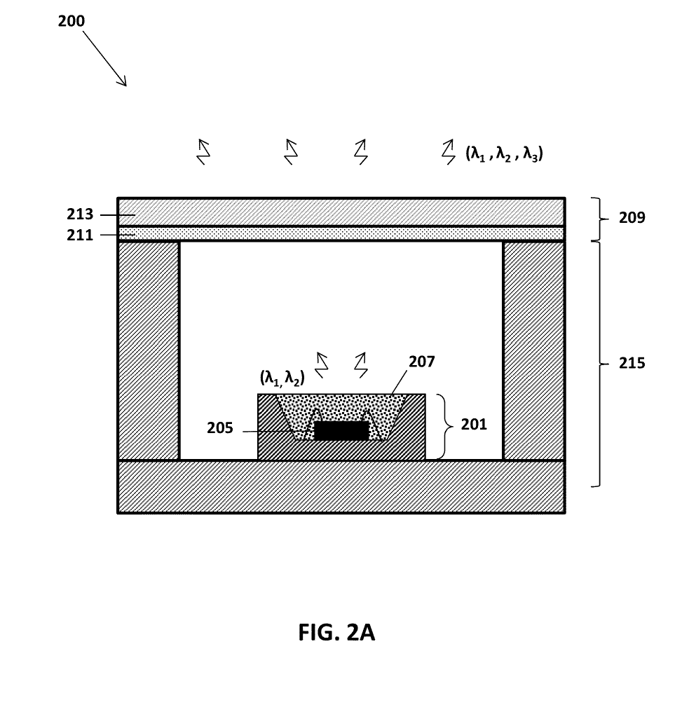

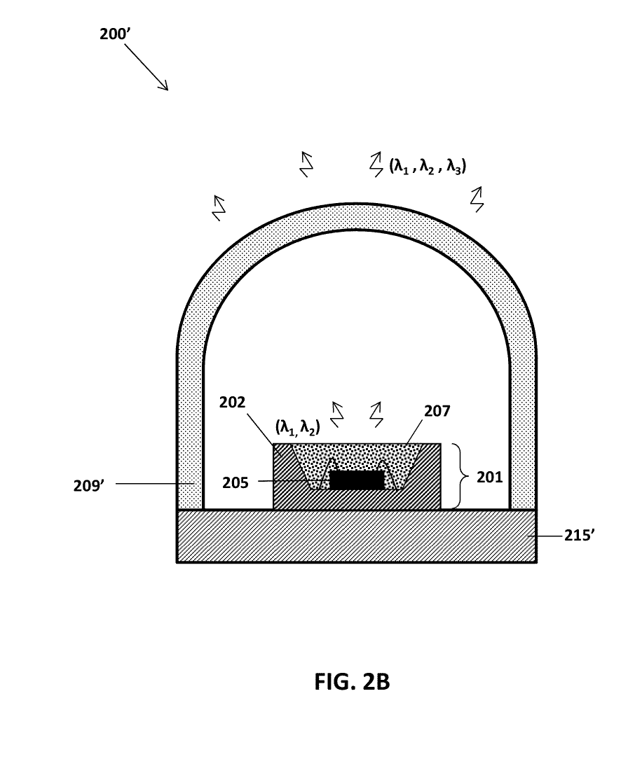

FIG. 2A illustrates a cross-sectional view of a light emitting device 200 according to some embodiments. The light emitting device 200 comprises a solid-state light source 205 such as a light emitting diode (LED) mounted in a cavity within a package 201. In some embodiments, the LED 205 may be a blue light emitting LED (e.g. light of a wavelength between 440 nm and 480 nm). In some other embodiments, the LED 205 may be a UV light emitting LED. A first wavelength conversion component 207 comprising first photo-luminescent material may be located within the package cavity 201 and configured to encapsulate the LED 205. In some embodiments, the first wavelength conversion component 207 may comprise a first photo-luminescent material, such as a red light emitting phosphor material, mixed with a light transmissive carrier material that fills the cavity and encapsulates the LED 205. In some other embodiments, the first wavelength conversion component 207 may comprise other photo-luminescent material such as quantum dots. A quantum dot is a portion of matter (e.g. semiconductor) whose excitons are confined in all three spatial dimensions that may be excited by radiation energy to emit light of a particular wavelength or range of wavelengths.

The light emitting device 200 may further comprise a second wavelength conversion component 209. The second wavelength conversion component 209 comprises a second photo-luminescent material. In some embodiments, the second wavelength conversion component 209 may comprise a wavelength conversion layer 211 that comprises the second photo-luminescent material and a light transmissive substrate 213. The second wavelength conversion component 209 may be configured such that the wavelength conversion layer 211 faces the light source 205. The light transmissive substrate 213 must be substantially transmissive to light in the visible spectrum (e.g. 380 nm-740 nm). Over such a wavelength range the light transmissive substrate 213 should be able to transmit at least 90% of visible light. In some embodiments, the wavelength conversion layer 211 may comprise a yellow and/or green light emitting phosphor material mixed with a carrier material. In some other embodiments, the wavelength conversion layer 211 may comprise other photo-luminescent material such as quantum dots.

Where the first and second photo-luminescent materials comprise phosphor materials, the phosphor material may be an inorganic or organic phosphor such as for example silicate-based phosphor of a general composition A₃Si(O,D)₅ or A₂Si(O,D)₄ in which Si is silicon, 0 is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in United States patents U.S. Pat. No. 7,575,697 B2 “Silicate-based green phosphors”, U.S. Pat. No. 7,601,276 B2 “Two phase silicate-based yellow phosphors”, U.S. Pat. No. 7,655,156 B2 “Silicate-based orange phosphors” and U.S. Pat. No. 7,311,858 B2 “Silicate-based yellow-green phosphors”. The phosphor can also comprise an aluminate-based material such as is taught in co-pending patent application U.S.2006/0158090 A1 “Novel aluminate-based green phosphors” and patent U.S. Pat. No. 7,390,437 B2 “Aluminate-based blue phosphors”, an aluminum-silicate phosphor as taught in co-pending application U.S.2008/0111472 A1 “Aluminum-silicate orange-red phosphor” or a nitride-based red phosphor material such as is taught in co-pending United States patent application U.S.2009/0283721 A1 “Nitride-based red phosphors” and International patent application WO2010/074963 A1 “Nitride-based red-emitting in RGB (red-green-blue) lighting systems”. It will be appreciated that the phosphor material is not limited to the examples described and can comprise any phosphor material including nitride and/or sulfate phosphor materials, oxy-nitrides and oxy-sulfate phosphors or garnet materials (YAG).

Where a carrier material is utilized, the carrier material must be substantially transmissive to light in the visible spectrum (e.g. 380 nm-740 nm). At such wavelengths, the carrier material should be able to transmit at least 90% of visible light. Such carrier materials may include a polymer resin, a monomer resin, an acrylic, an epoxy, a silicone, or a fluorinated polymer.

In the embodiments shown in FIG. 2A, the first wavelength conversion component 207 is contact with the light source 205 and the second wavelength conversion component 209 positioned remotely to the light source 205. Since the first wavelength conversion component 207 is in closer proximity to the light source 205 than the second wavelength conversion component 209, the first photo-luminescent material is provided over a much smaller area than the area over which the second photo-luminescent material is provided. As a result, generating a selected color of light requires a much lower quantity of the first photo-luminescent material compared with the quantity of the second photo-luminescent material. In some embodiments, the first wavelength conversion component 207 may have an area that is at least two times smaller than the area of the second wavelength conversion component 209. In other embodiments the first wavelength conversion component 207 may have an area that is at least ten, fifty or even one hundred times smaller than the area of the second wavelength conversion component 209.

In some embodiments, and as shown in FIG. 2A, the second wavelength conversion component 209 may be located on top of a light emitting device housing 215 associated with the light emitting device 200. The light emitting device housing 215 may include sidewalls and a base and the package 201 may be located within the housing 215 and in thermal communication with the base. The second wavelength conversion component 209 may be located on top of the sidewalls of the light emitting device housing 215.

In operation, the light source (e.g. LED) 205 generates excitation light of a certain color λ₁ (typically blue). A portion of the excitation light may be absorbed by the first photo-luminescent material of the first wavelength conversion component 207 and converted into light of another color λ₂ (typically orange or red). The remaining proportion of the excitation light may be transmitted by the first wavelength conversion component 207. The first wavelength conversion component 207 thus has an emission product that comprises a combination of blue excitation light generated by the light source 205 and red light generated by the first photo-luminescent material 207 and is bluish purple in color.

The emission product of the first wavelength conversion component 207 is then directed towards the second wavelength conversion component 209. The component of light λ₂ generated by the first wavelength conversion component is transmitted through the second wavelength conversion component 209. A proportion of the excitation light λ₁ generated by the light source 205 that was not absorbed by the first photo-luminescent material is absorbed by the wavelength conversion layer 211 of the second wavelength conversion component 209 and converted into light of another color λ₃ (typically yellow or yellow green). The remaining proportion of blue excitation light that was not absorbed by the first wavelength conversion component 207 is transmitted through the second wavelength conversion component 209 and contributes to the final emission product of the device 200. A final emission product of the light emitting device 200 is thus a combination of blue excitation light generated by the light source 205, red light generated by the first wavelength conversion component 207, and light generated by the second wavelength conversion component 209. By appropriately configuring the quantities of the first and second photo-luminescent materials, a final emission product that appears white can be achieved.

Light generated by a wavelength conversion component 207, 209 refers to converted light that is emitted by the photo-luminescent material of the wavelength conversion component (e.g., light that has been converted by a process of photoluminescence to another color).

Utilizing a light emitting device 200 with a first wavelength conversion component 207 that is closer in proximity to the light source 205 and smaller in size than a second wavelength conversion component 209, reduces overall costs of the light emitting device 200. Reducing the area of the first wavelength conversion component 207, enables a total amount of the first photo-luminescent material to be reduced. Additionally, placing the first wavelength conversion component 207 in closer proximity to the light source 205 allows the light emitting device 200 to generate a final emission product with a required amount of light of a color generated by the first wavelength conversion component 207 whilst reducing the amount of photo-luminescent material needed to achieve the desired amount. This is because the color of light generated by the wavelength conversion component depends largely on the density of photo-luminescent material per unit area and thus a smaller amount of photo-luminescent material is required to generate the same quantity of converted light when the proximity of the wavelength conversion component to the light source is reduced.

For example, a light emitting device may include a first wavelength conversion component 207 that comprises a photo-luminescent material that is more cost prohibitive (e.g. red phosphor material) and a second wavelength conversion component 209 that comprises a photo-luminescent material that is less cost prohibitive (e.g. yellow and green phosphor materials). As described the red phosphor material may be placed in the first wavelength conversion component (e.g. within the light source package) while the yellow and green phosphor materials are placed in the second wavelength conversion component as opposed to having all three phosphor materials placed in the same wavelength conversion component. The final emission product of such a light emitting device will achieve the same color quality as that of a final emission product of a light emitting device with all three phosphor materials in the same wavelength conversion component, while significantly reducing costs by reducing the amount of red phosphor material used.

Additionally, placing the red phosphor material and green phosphor material in separate wavelength conversion components resolves undesirable effects that may arise due to cross-absorption. Cross-absorption occurs when green phosphor material and red phosphor material are blended together in the same wavelength conversion component for a given light emitting device. A portion of the green light generated by the wavelength conversion component may be converted to red light by the red phosphor material. This results in a decreased CRI of the final emission product of the light emitting device. However, by separating the red phosphor material and green phosphor material into separate wavelength conversion components, an increased CRI may be achieved that is otherwise unattainable where the different phosphor materials are blended together in the same wavelength conversion component.

Moreover, because phosphor materials are typically “down converting” (e.g., higher energy light is converted/shifted to light of a lower energy and longer wavelength), phosphor materials are typically transparent to light of a lower energy, that is of a longer wavelength. For example, green phosphor material is substantially tranmissive to red light, but it absorbs blue excitation light and converts it to green light. Thus, by having the first and second photo-luminescent materials ordered as described in the above example, red light generated by the red phosphor material may pass through the yellow/green phosphor materials of the second wavelength conversion component without significant loss.

The concept of a package comprising a blue light source and a red phosphor material and using the package to excite a remote wavelength conversion component is believed to be inventive in its own right.

FIG. 2B illustrates a cross-sectional of a light emitting device 200′ in accordance with some embodiments. The light emitting device of FIG. 2B is a three-dimensional configuration of the light emitting device of FIG. 2A. For purposes of discussion, only features of the light emitting device of FIG. 2B that are new relative to the embodiments of FIG. 2A will be described.

Whereas the second wavelength conversion component 209 of the light emitting device in FIG. 2A has a two-dimensional shape (i.e. is generally planar), the second wavelength conversion component 209′ of FIG. 2B has a three-dimensional shape (e.g. elongated dome shaped and/or ellipsoidal shell). The three-dimensional second wavelength conversion component 209′ in FIG. 2B may comprise a phosphor material embedded within a carrier material without the addition of a light transmissive substrate.

The second wavelength conversion component 209′ may form an enclosure that encloses the package 201, e.g., the package 201 is within an interior volume 290 that is defined by the inner surfaces of the second wavelength conversion component 209′. The second wavelength conversion component 209′ may be attached to the housing 215′ of the light emitting device 200′. The housing 215′ of the light emitting device 201 may include only a base and no sidewalls when the second wavelength conversion component 209′ encloses the light source package 201. Configuring the second wavelength conversion component 209′ to be three-dimensional rather than two-dimensional may be useful for applications where it is necessary for light emitted from the light emitting device to be spread over a larger solid angle.

While the light emitting device described above with respect to FIG. 2A comprises a package with a first wavelength conversion component comprising a first photo-luminescent material that encapsulates the LED, several other configurations for a light emitting device with multiple photo-luminescent materials may also be used. For example the first photo-luminescent material may be provided in a first wavelength conversion component that is located remotely to the light source.

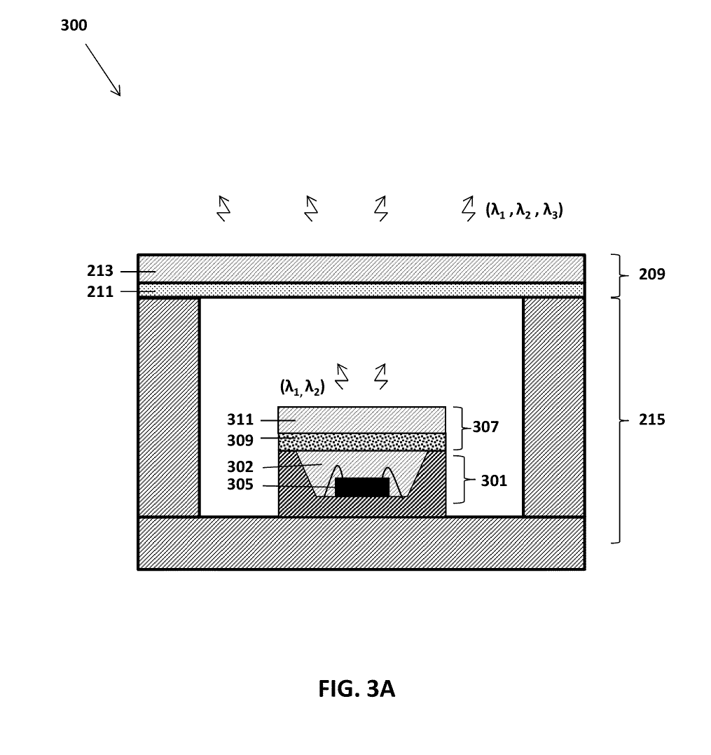

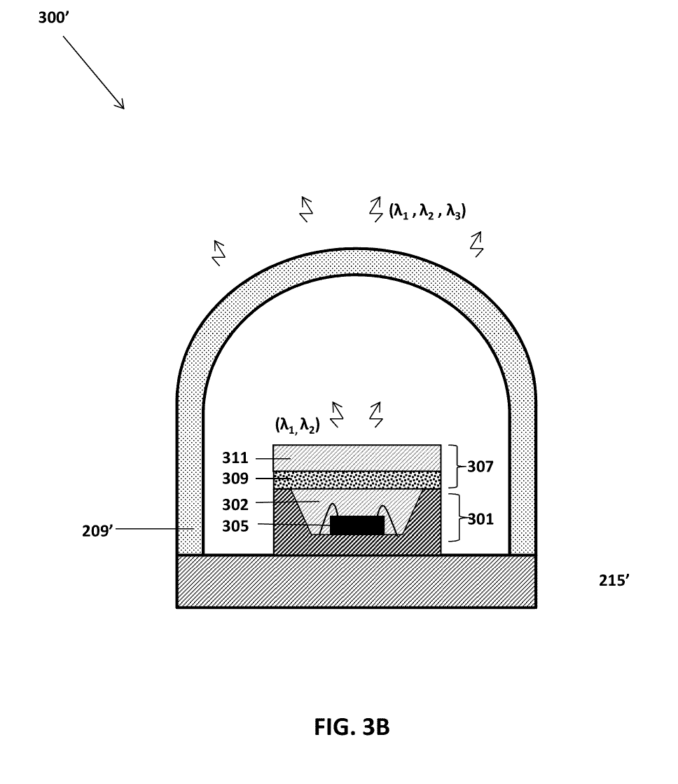

FIG. 3A illustrates a cross-sectional view of a light emitting device 300 in accordance with some embodiments. The light emitting device 300 of FIG. 3A operates substantially the same as the light emitting device of FIG. 2A. For purposes of discussion, only features of the light emitting device 300 of FIG. 3A that are new relative to the embodiments of FIG. 2A will be described.

As shown in FIG. 3A, and in contrast to the embodiments of FIGS. 2A and 2B, the first photo-luminescent material is incorporated in a first wavelength conversion component 307 that is located remotely to the solid-state light source 305. In such embodiments the light source 305 may be located within a cavity of a package 301 with a light transmissive encapsulation 302 covering the light source 305. The first wavelength conversion component 307 may then be placed on top of the package 301 such that the first wavelength conversion component 307 is remote to the light source 305. This is in contrast to FIGS. 2A and 2B in which the first wavelength conversion component comprising first photo-luminescent material is located within the package 301 and encapsulates the light source 305. In some embodiments, the first wavelength conversion component 307 may include a wavelength conversion layer 309 and a light transmissive substrate 311. The wavelength conversion layer 309 may comprise a mixture of a phosphor material in a carrier material.

FIG. 3B illustrates a cross-sectional of a light emitting device 300′ in accordance with some embodiments. The light emitting device 300′ of FIG. 3B is a three-dimensional configuration of the light emitting device 300 of FIG. 3A. For purposes of discussion, only features of the light emitting device of FIG. 3B that are new relative to the embodiments of FIG. 3A will be described.

Whereas the second wavelength conversion component of the light emitting device 209 in FIG. 3A has a two-dimensional shape (e.g. is substantially planar), the second wavelength conversion component 209′ of FIG. 3B has a three-dimensional shape (e.g. elongated dome shaped and/or ellipsoidal shell). The three-dimensional second wavelength conversion component 209′ in FIG. 3B may comprise a phosphor material embedded within a carrier material without the addition of a light transmissive substrate.

The second wavelength conversion component 209′ may form an enclosure that encloses the light source package 301 and the first wavelength conversion component 307. The second wavelength conversion component 209′ may be attached to the housing 215′ of the light emitting device 300′. The housing 215′ of the light emitting device 300′ may include only a base and no sidewalls when the second wavelength conversion component 209′ encloses the excitation source 301.

As discussed above, configuring the wavelength conversion component to be three-dimensional rather than two-dimensional may be useful for applications where it is required for light to be emitted over a range of solid angles.

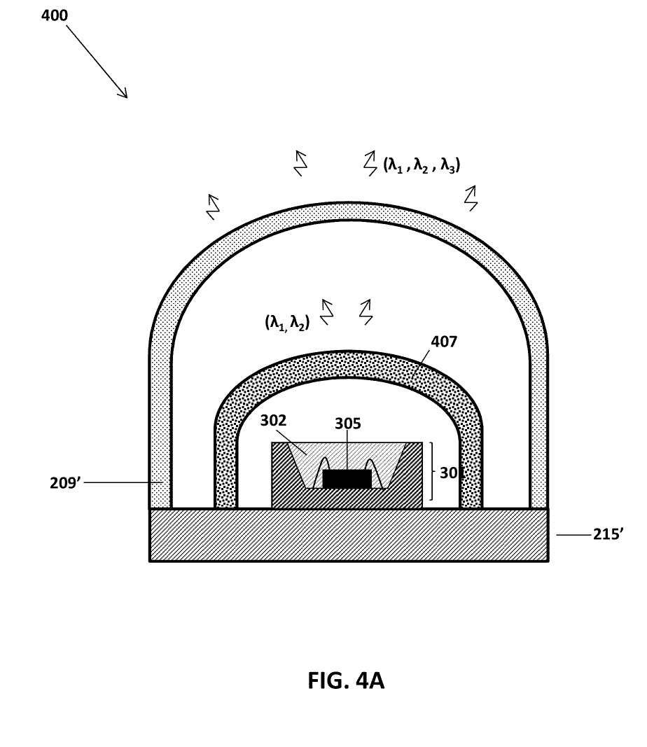

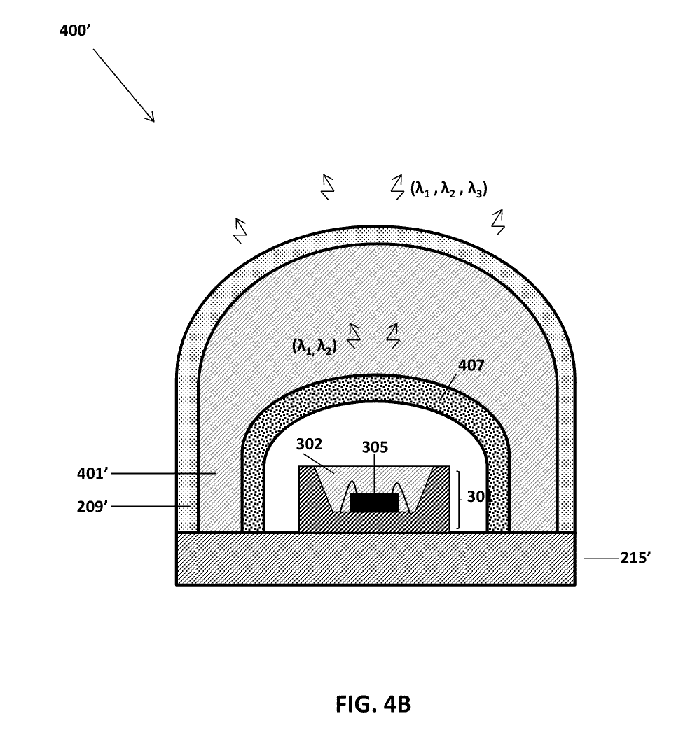

FIG. 4A illustrates a cross-sectional view of a light emitting device 400 in accordance with some embodiments. The light emitting device 400 of FIG. 4A operates substantially the same as the light emitting device of FIG. 3B. For purposes of discussion, only features of the light emitting device of FIG. 4A that are new relative to the embodiments of FIG. 3B will be described.

The first wavelength conversion component 407 of FIG. 4A is located remotely from the light source 305. The first wavelength conversion component 407 forms an enclosure that encloses the light source package 301. The first wavelength conversion component 407 may be attached to the light emitting device housing 215′. The light emitting device housing 215′ may include only a base and no sidewalls when the second wavelength conversion component 209′ encapsulates the light source 305.

In some embodiments, the first wavelength conversion component 407 may be a separate article from the second wavelength conversion component 209′. For example, the first wavelength conversion component 407 and the second wavelength conversion component 209′ may be individually attached to the housing 215′ of the light emitting device 400. In some other embodiments, the first wavelength conversion component 407 and the second wavelength conversion component 209′ may be combined in a single entity. In these embodiments, the first wavelength conversion component 407 and the second wavelength conversion component 209′ may not be individually attached to the housing 215′ of the light emitting device 400.

FIG. 4B illustrates a cross-sectional of a light emitting device 400′ in accordance with some embodiments. The light emitting device 400′ of FIG. 4B operates substantially the same as the light emitting device 400 of FIG. 4A. For purposes of discussion, only features of the light emitting device 400′ of FIG. 4B that are new relative to the embodiments of FIG. 4B will be described.

An additional light transmissive medium 401′ may be provided between the first wavelength conversion component 407 and the second wavelength conversion component 209′. The additional light transmissive medium 401′ must be substantially transmissive to light in the visible spectrum (e.g. 380 nm-740 nm). At such wavelengths the additional light transmissive medium 401′ should be able to transmit at least 90% of visible light.

The additional light transmissive medium 401′ may be configured to be in contact with an outer surface, that is a surface facing away from the light source 305, of the first wavelength conversion component 407. The additional light transmissive medium 401′ may also be configured to be in contact with an inner surface, that is a surface facing the light source 305, of the second wavelength conversion component 209′. By introducing an additional light transmissive substrate 401′, a desired index of refraction may be achieved between an interface of the first wavelength conversion component 407 and the second wavelength conversion component 209′.

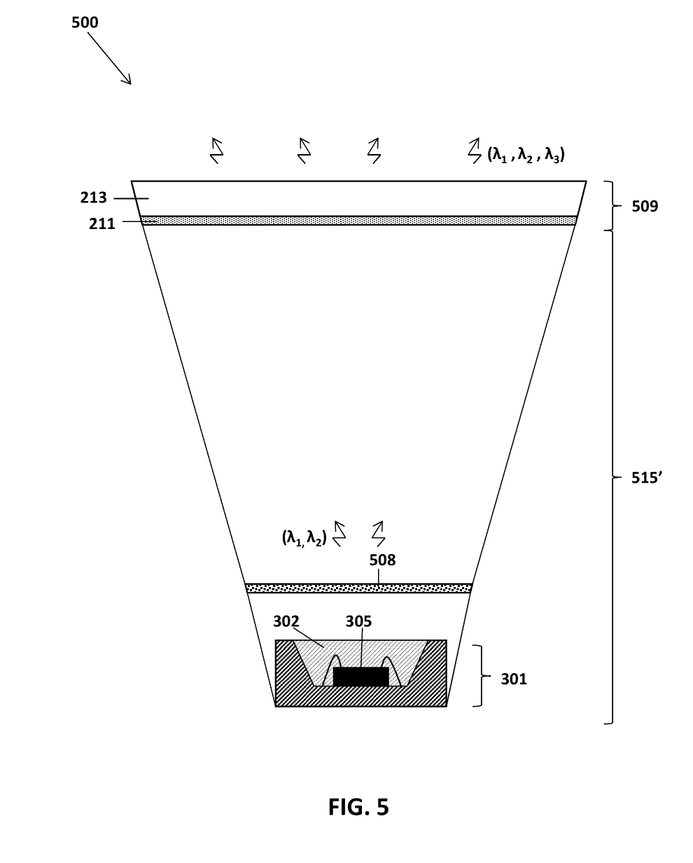

FIG. 5 illustrates a cross-sectional of a light emitting device 500 in accordance with some embodiments. The light emitting device 500 of FIG. 5 operates substantially the same as the light emitting device of FIG. 3A. For purposes of discussion, only features of the light emitting device 500 of FIG. 5 that are new relative to the embodiments of FIG. 3A will be described.

The light emitting device 500 of FIG. 5 is shaped like a frustum of a cone. The light emitting device housing 515′ may include a light reflective sidewall shaped in the form of a frustum of a cone and a base. The light source package 301 may be attached to the base of the light emitting device housing 515′. The first wavelength conversion component 508 may be attached to a lower portion of the sidewall of the light emitting device housing 515′. In some embodiments, the second wavelength conversion component 509 may be placed on top of the light emitting device housing 515′ as illustrated in FIG. 5. In some other embodiments, the second wavelength conversion component 509 may be attached to an upper portion of the sidewall of the light emitting device housing 515′.

Not only does utilizing a light emitting device with a first wavelength conversion component that is closer in proximity to the excitation source and smaller in area than a second wavelength conversion component lower overall costs, it also has additional benefits. For example, the invention also addresses a problem with many light emitting devices that utilize remote wavelength conversion in that the wavelength conversion components that include red phosphor appear yellow-orange in an off-state, a color that is aesthetically displeasing to some users due to its dissimilarity to an incandescent or fluorescent light bulb in an off-state (e.g. white). However, when a wavelength conversion component includes only yellow or green phosphor materials, the appearance takes on a more pale yellow tone, which more closely resembles an incandescent or fluorescent bulb. By placing red phosphor material in a relatively interior wavelength conversion component and yellow/green phosphor materials in a relatively exterior wavelength conversion component, the light emitting device may maintain a more pale yellow exterior appearance, which may be more aesthetically pleasing to some users.

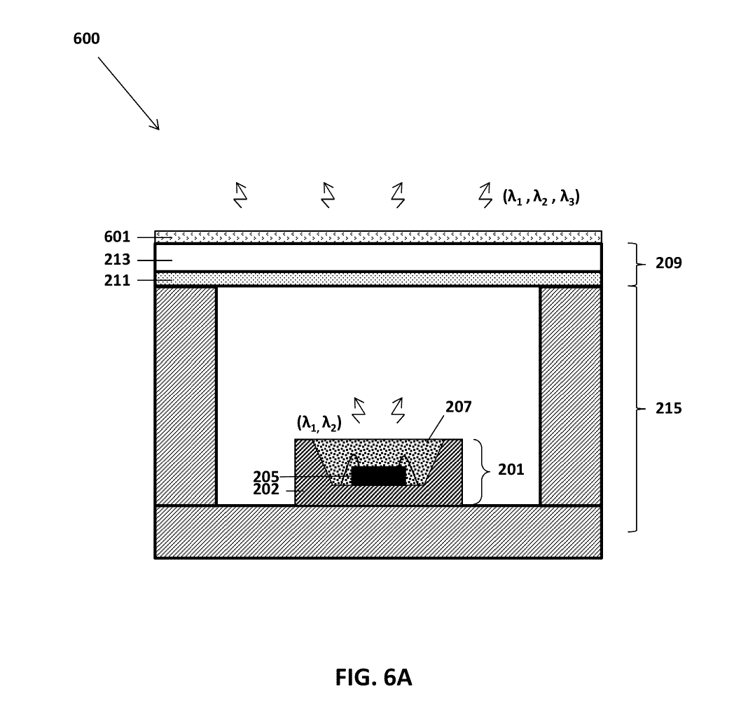

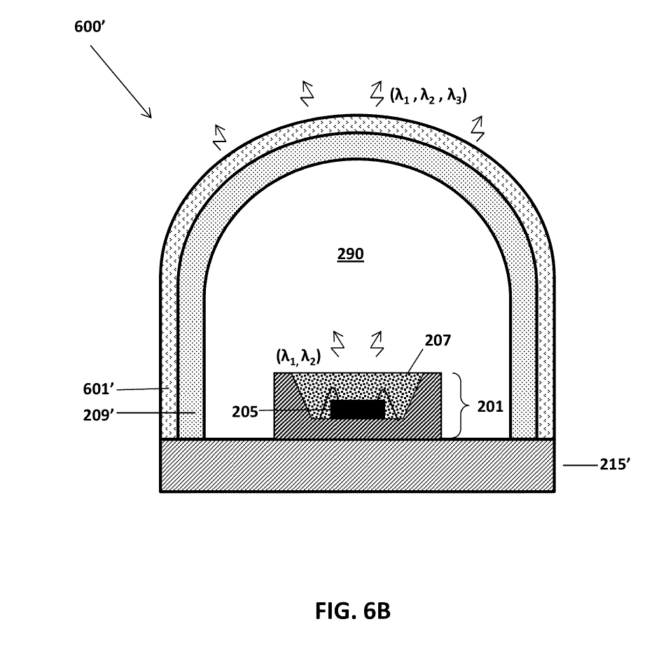

In some embodiments, the light emitting device may include an additional light diffusing layer on top of the second wavelength conversion component. FIG. 6A illustrates the light emitting device of FIG. 2A with an additional light diffusing layer 601. For purposes of discussion, only features of the light emitting device 600 of FIG. 6A that are new relative to the embodiments of FIG. 2A will be described.

In some embodiments, the diffusing layer 601 may be in contact with an outer surface, that is a surface facing away from the light source package 201, of the light transmissive substrate 213 of the second wavelength conversion component 209. The diffusing layer 601 may comprise a mixture comprising a layer of particles of a light scattering material in a light transmissive carrier material. The layer of particles of a light scattering material may preferably comprise titanium dioxide (TiO₂). In alternative arrangements the light diffractive material can comprise barium sulfate (BaSO₄, magnesium oxide (MgO), silicon dioxide (SiO₂), aluminum oxide (Al₂O₃) or a powdered material with as high a reflectivity as possible, typically a reflectance of 0.9 or higher. Further details regarding a suitable approach for implementing a diffusing layer is described in co-pending U.S. application Ser. No. ______, Attorney Docket No. ITMX-VISTA-00318U.S.1, entitled “SOLID-STATE LIGHT EMITTING DEVICES WITH REMOTE PHOSPHOR WAVELENGTH CONVERSION COMPONENT”, filed on even date herewith, which is hereby incorporated by reference in its entirety.

The addition of a light diffusing layer 601 provides the benefit of improving the visual appearance of the light emitting device 600 in an off-state. As discussed above, removing red phosphors from the second wavelength conversion component 209 creates a more pale yellow exterior appearance for the light emitting device 600. However, the pale yellow exterior appearance of the light emitting device 600 may be improved to further reduce the yellow appearance with the addition of the light diffusing layer 601. In part, this is because the light diffusing layer 601 includes particles of a light scattering material that can substantially reduce the passage of external excitation light that would otherwise cause the second wavelength conversion component 209 to re-emit light of a wavelength having a yellowish color. Additionally, because the diffusing layer 601 is the layer externally visible rather than the second wavelength conversion component 209, the yellow appearance may be significantly reduced.

The diffusing layer 601 may also provide the added benefits of reducing phosphor material usage. The diffusing layer 601 increases the probability that the second wavelength conversion component 209 generates photoluminescence light by scattering a portion of the excitation light generated by the light source 205 that is transmitted through both the first wavelength component 208 and second wavelength component 209 back into the second wavelength conversion component 209.

FIG. 6B illustrates a three-dimensional configuration of the light emitting device of FIG. 6A. For purposes of discussion, only features of the light emitting device 600′ of FIG. 6B that are new relative to the embodiments of FIG. 6A will be described.

Whereas the diffusing layer 601 and the second wavelength conversion component 209 of the light emitting device 600 in FIG. 6A have a two-dimensional shape (i.e. substantially planar), the diffusing layer 601′ and second wavelength conversion component 209′ of FIG. 6B have a three-dimensional shape (e.g., elongated dome-shaped and/or ellipsoidal shell). The three-dimensional second wavelength conversion component 209′ in FIG. 6B may comprise a phosphor material embedded within a carrier material thereby eliminating the need for a light transmissive substrate.

While the addition of a diffusing layer has only been described with respect to FIG. 6A and 6B, it should be noted that the diffusing layer may be added to the second wavelength conversion component of any of the light emitting devices described above.

When the second wavelength conversion component (e.g., larger area and further in proximity to light source) comprises green phosphor material and the first wavelength conversion component (e.g., smaller area and closer in proximity to light source) comprises red phosphor material, the green phosphor material may act as a partial diffuser to assist with color blending and to improve color over angle consistency for the final emission product of the light emitting device. Thus, having the green phosphor material in the second wavelength conversion component allows for less light scattering material to be used in a diffusing layer.

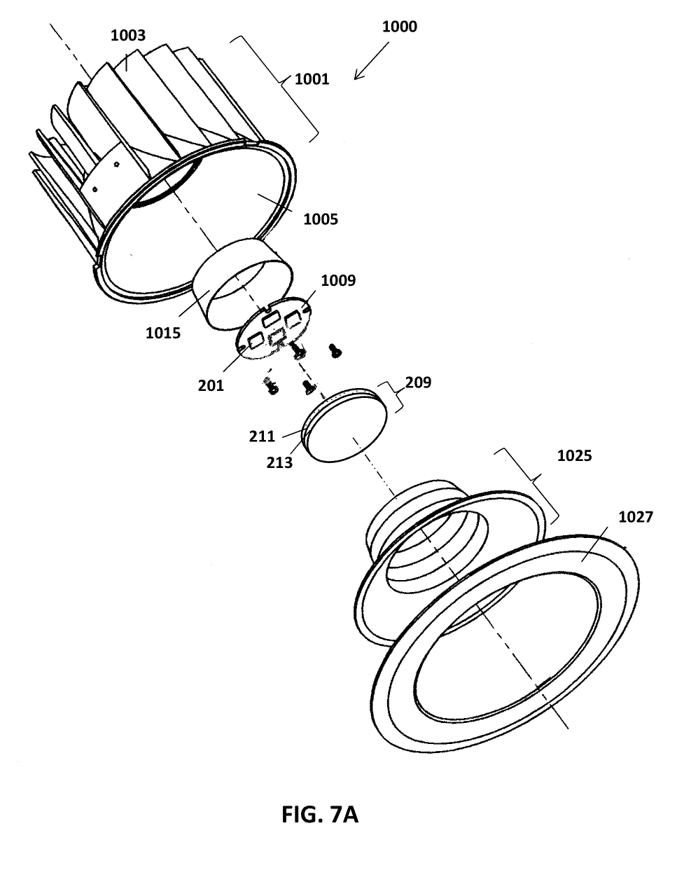

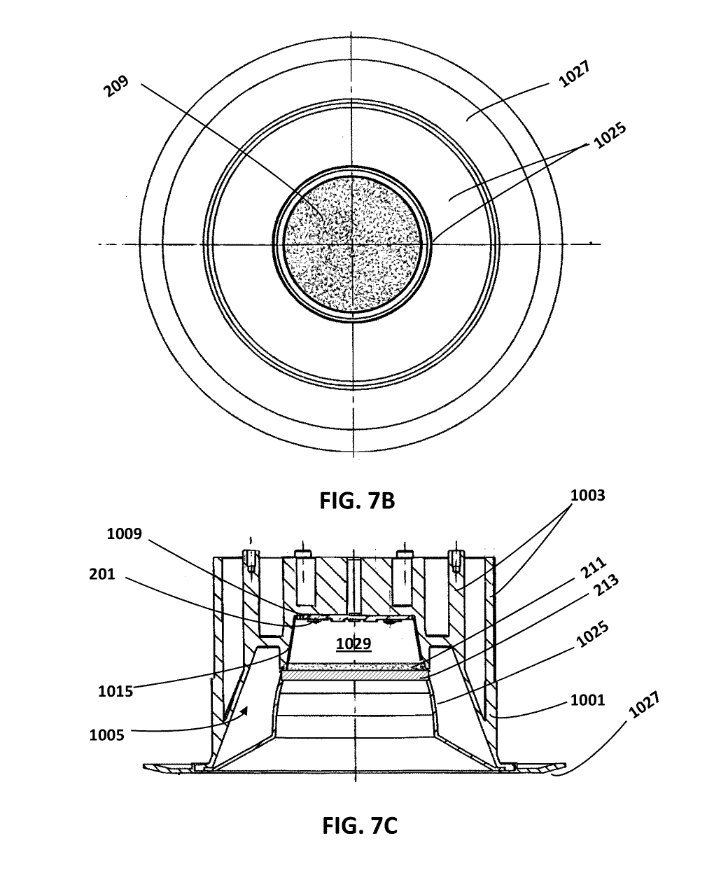

FIGS. 7A, 7B, and 7C illustrate an example of an application of a light emitting device in accordance with some embodiments. FIG. 7A, 7B, and 7C illustrates an LED downlight 1000 in accordance with some embodiments. FIG. 7A is an exploded perspective view of the LED downlight 1000, FIG. 7B is an end view of the downlight 1000, and FIG. 7C is a sectional view of the downlight 1000. The downlight 1000 is configured to generate light with an emission intensity of 650-700 lumens and a nominal beam spread of 60° (wide flood). It is intended to be used as an energy efficient replacement for a conventional incandescent six inch downlight.

The downlight 1000 comprises a hollow generally cylindrical thermally conductive body 1001 fabricated from, for example, die cast aluminum. The body 1001 functions as a heat sink and dissipates heat generated by the light emitting packages 201. To increase heat radiation from the downlight 1000 and thereby increase cooling of the light emitting device 1000, the body 1001 can include a series of latitudinal spirally extending heat radiating fins 1003 located towards the base of the downlight 1001. To further increase the radiation of heat, the outer surface of the body can be treated to increase its emissivity such as for example painted black or anodized. The body 1001 further comprises a generally frustoconical (i.e. a cone whose apex is truncated by a plane that is parallel to the base) axial chamber 1005 that extends from the front of the body a depth of approximately two thirds of the length of the body. The form factor of the body 1001 is configured to enable the downlight to be retrofitted directly in a standard six inch downlighting fixture (can) as are commonly used in the United States.

Four solid state light emitting packages 201, such as the ones described above in FIG. 2A, may be mounted on a circular shaped MCPCB (Metal Core Printed Circuit Board) 1009. A first wavelength conversion component (not shown) comprising first photo-luminescent material is located within a cavity of each light emitting package 201 and configured to encapsulate the light emitter within each light emitting package 201.

As is known an MCPCB 1009 comprises a layered structure composed of a metal core base, typically aluminum, a thermally conducting/electrically insulating dielectric layer and a copper circuit layer for electrically connecting electrical components in a desired circuit configuration. With the aid of a thermally conducting compound such as for example a standard heat sink compound containing beryllium oxide or aluminum nitride the metal core base of the MCPCB 1009 is mounted in thermal communication with the body via the floor of the chamber 1005. As shown in FIG. 7A the MCPCB 1009 can be mechanically fixed to the body floor by one or more screws, bolts or other mechanical fasteners.

The downlight 1000 further comprises a hollow generally cylindrical light reflective chamber wall mask 1015 that surrounds the array of light emitting packages 201. The chamber wall mask 1015 can be made of a plastics material and preferably has a white or other light reflective finish. A second wavelength conversion component 209, such as the one described above in FIG. 2A, may be mounted overlying the front of the chamber wall mask 1015 using, for example, an annular steel clip that has resiliently deformable barbs that engage in corresponding apertures in the body. The second wavelength conversion component 209 is remote to the light emitters. The second wavelength conversion component 209 comprises a wavelength conversion layer 211 and a light transmissive substrate 213. The first wavelength conversion component is closer in proximity to the light emitters and smaller in size than a second wavelength conversion component 209.

Utilizing a first wavelength conversion component that is closer in proximity to the light emitters and smaller in size than a second wavelength conversion component, reduces overall costs of the downlight 1000. Reducing the area of the first wavelength conversion component enables a total amount of the first photo-luminescent material to be reduced. Additionally, placing the first wavelength conversion component in closer proximity to the light emitters allows the downlight 1000 to generate a final emission product with a required amount of light of a color generated by the first wavelength conversion component whilst reducing the amount of photo-luminescent material needed to achieve the desired amount. Furthermore, the light emitting device may maintain a more pale yellow exterior appearance when red phosphor is included in the first wavelength conversion component and yellow and green phosphor is included in the second wavelength conversion component as discussed above, which may be more aesthetically pleasing to some users. In some embodiments, the addition of a light diffusing layer to the second wavelength conversion component provides the benefit of further improving the visual appearance of the light emitting device in an off-state by further reducing the yellow external appearance, as described above.

The downlight 1000 further comprises a light reflective hood 1025 which is configured to define the selected emission angle (beam spread) of the downlight (i.e. 60° in this example). The hood 1025 comprises a generally cylindrical shell with three contiguous (conjoint) inner light reflective frustoconical surfaces. The hood 1025 is preferably made of Acrylonitrile butadiene styrene (ABS) with a metallization layer. Finally the downlight 1000 can comprise an annular trim (bezel) 1027 that can also be fabricated from ABS.

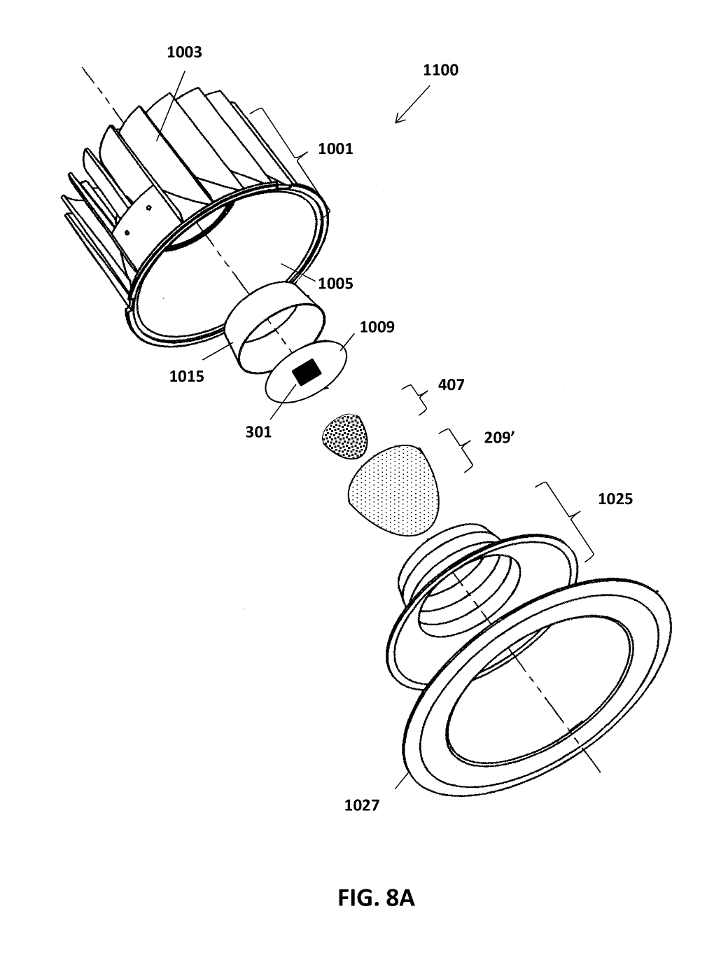

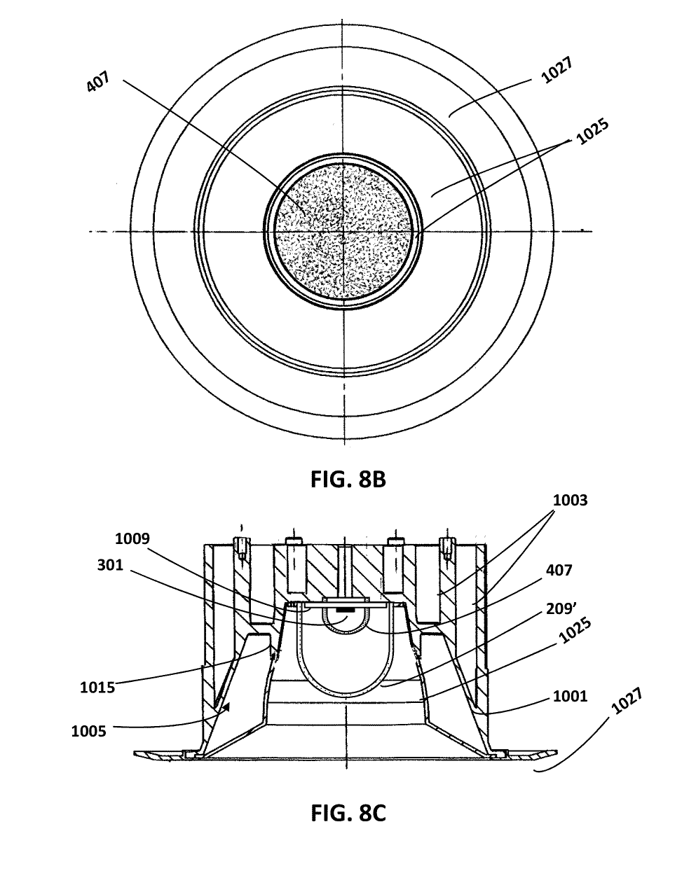

FIGS. 8A, 8B, and 8C illustrate another example of an application of a light emitting device in accordance with some embodiments. FIGS. 8A, 8B, and 8C illustrate an LED downlight 1100 that utilizes remote wavelength conversion in accordance with some embodiments. FIG. 8A is an exploded perspective view of the LED downlight 1100, FIG. 8B is an end view of the downlight 1100, and FIG. 8C is a sectional view of the downlight 1100. The downlight 1100 is configured to generate light with an emission intensity of 650-700 lumens and a nominal beam spread of 60° (wide flood). It is intended to be used as an energy efficient replacement for a conventional incandescent six inch downlight.

The downlight 1100 of FIGS. 8A, 8B, and 8C is substantially the same as the downlight 1000 of FIGS. 7A, 7B, and 7C. For purposes of discussion, only features of the downlight 1100 that are new relative to the embodiments of FIGS. 7A, 7B, and 7C will be described.

The downlight 1100 of FIGS. 8A, 8B, and 8C has a single light emitting package 301, such as the one described in FIG. 3A, located on the MCPCB 1009. Additionally, whereas the first wavelength conversion component of FIGS. 7A, 7B, and 7C is located within a cavity of each light emitting package and configured to encapsulate the light emitter within each light emitting package, the first wavelength conversion component of FIGS. 8A, 8B, and 8C is located remote to the light emitters. The first wavelength conversion component 407 has a three-dimensional shape (e.g., elongated dome shaped and/or ellipsoidal shell) and is substantially the same as the first wavelength conversion component of FIG. 4A. The first wavelength conversion component 407 forms an enclosure that encloses a light source package 301 and may also be mounted enclosing the front of the chamber wall mask 1015.

Furthermore, whereas the second wavelength conversion component 209 of FIGS. 7A, 7B, and 7C has a two-dimensional shape (e.g., is substantially planar), the second wavelength conversion component 209′ of FIGS. 8A, 8B, and 8C has a three-dimensional shape (e.g., elongated dome shaped and/or ellipsoidal shell). The three-dimensional second wavelength conversion component 209′ may comprise a phosphor material embedded within a carrier material without the addition of a light transmissive substrate, such as the one described above in FIG. 2B. The second wavelength conversion component 209′ may also be mounted enclosing the front of the chamber wall mask 1015. The first wavelength conversion component 407 is closer in proximity to the light emitters and smaller in size than the second wavelength conversion component 209′.

As discussed above, utilizing a first wavelength conversion component that is closer in proximity to the light emitters and smaller in size than a second wavelength conversion component, reduces overall costs of the downlight 1100. Reducing the area of the first wavelength conversion component enables a total amount of the first photo-luminescent material to be reduced. Additionally, placing the first wavelength conversion component in closer proximity to the light emitters allows the downlight 1100 to generate a final emission product with a required amount of light of a color generated by the first wavelength conversion component whilst reducing the amount of photo-luminescent material needed to achieve the desired amount. Furthermore, the light emitting device may maintain a more pale yellow exterior appearance when red phosphor is included in the first wavelength conversion component and yellow and green phosphor is included in the second wavelength conversion component as discussed above, which may be more aesthetically pleasing to some users. In some embodiments, the addition of a light diffusing layer to the second wavelength conversion component provides the benefit of further improving the visual appearance of the light emitting device in an off-state by further reducing the yellow external appearance, as described above.

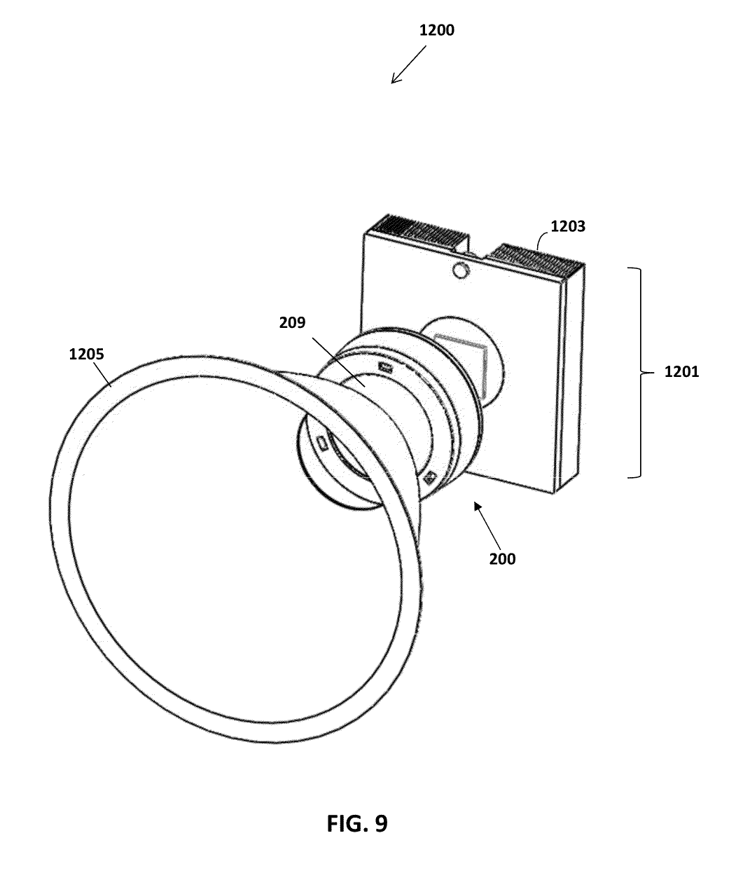

FIG. 9 illustrates another example of an application of a light emitting device in accordance with some embodiments. FIG. 9 illustrates an exploded perspective view of a reflector lamp 1200 in accordance with some embodiments. The reflector lamp 1200 is configured to generate light with an emission intensity of 650-700 lumens and a nominal beam spread of 60° (wide flood). It is intended to be used as an energy efficient replacement for a conventional incandescent six inch downlight.

The reflector lamp 1200 comprises a generally rectangular thermally conductive body 1201 fabricated from, for example, die cast aluminum. The body 1201 functions as a heat sink and dissipates heat generated by a light emitting device 200, such as the one described above in FIG. 2A. To increase heat radiation from the reflector lamp 1200 and thereby increase cooling of the light emitting device 200, the body 1201 can include a series of heat radiating fins 1203 located on the sides of the body 1201. To further increase the radiation of heat, the outer surface of the body 1201 can be treated to increase its emissivity such as for example painted black or anodized. The body 1201 further comprises a thermally conductive pad that may be placed in contact with a thermally conductive base of the light emitting device 200. The form factor of the body 1201 is configured to enable the reflector lamp 1200 to be retrofitted directly in a standard six inch downlighting fixture (a “can”) as are commonly used in the United States.

The light emitting device 200 includes a light emitting package (not shown) with a first wavelength conversion component comprising first photo-luminescent material located within the package cavity and configured to encapsulate light emitters located within the cavity. The light emitting device 200 may also include a second wavelength conversion component 209 such as the one described above with respect to FIG. 2A. The second wavelength conversion component 209 may be located on top of a light emitting device housing associated with the light emitting device 200. The first wavelength conversion component is closer in proximity to the light emitters and smaller in size than the second wavelength conversion component 209.

While not illustrated, the second wavelength conversion component 209 may include a wavelength conversion layer and a light transmissive substrate. The light emitting device 200 may be attached to the body 1201 such that the thermally conductive base of the light emitting device 200 may be in thermal contact with the thermally conductive pad of the body 1201.

As discussed above, utilizing a first wavelength conversion component that is closer in proximity to the light source and smaller in size than a second wavelength conversion component, reduces overall costs of the reflector lamp 1200. Reducing the area of the first wavelength conversion component enables a total amount of the first photo-luminescent material to be reduced. Additionally, placing the first wavelength conversion component in closer proximity to the light source allows the reflector lamp 1200 to generate a final emission product with a required amount of light of a color generated by the first wavelength conversion component whilst reducing the amount of photo-luminescent material needed to achieve the desired amount. Furthermore, the light emitting device may maintain a more pale yellow exterior appearance when red phosphor is included in the first wavelength conversion component and yellow and green phosphor is included in the second wavelength conversion component as discussed above, which may be more aesthetically pleasing to some users. In some embodiments, the addition of a light diffusing layer to the second wavelength conversion component provides the benefit of further improving the visual appearance of the light emitting device in an off-state by further reducing the yellow external appearance, as described above.

The reflector lamp 1200 further comprises a generally frustroconical light reflector 1205 having a paraboloidal light reflective inner surface which is configured to define the selected emission angle (beam spread) of the downlight (i.e. 60° in this example). The reflector 1205 is preferably made of Acrylonitrile butadiene styrene (ABS) with a metallization layer.

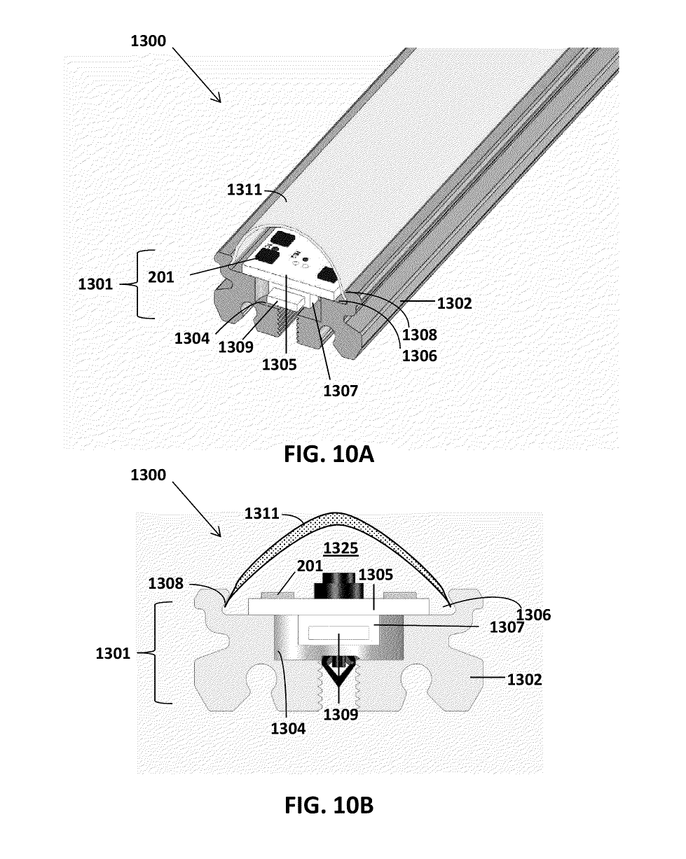

FIGS. 10A and 10B illustrate another example of an application of a light emitting device in accordance with some embodiments. FIGS. 10A and 10B illustrate an LED linear lamp 1300 that utilizes remote wavelength conversion in accordance with some embodiments. FIG. 10A is a three-dimensional perspective view of the linear lamp 1300 and FIG. 10B is a cross-sectional view of the linear lamp 1300. The LED linear lamp 1300 is intended to be used as an energy efficient replacement for a conventional incandescent or fluourescent tube lamp.

The linear lamp 1300 comprises an elongated thermally conductive body 1301 fabricated from, for example, die cast aluminum. The form factor of the body 1301 is configured to be mounted with a standard linear lamp housing. The body 1301 further comprises a first recessed channel 1304, wherein a rectangular tube-like case 1307 containing some electrical components (e.g., electrical wires) of the linear lamp 1300 may be situated. The case 1307 may further comprise an electrical connector (e.g., plug) 1309 extending past the length of the body 1301 on one end, and a recessed complimentary socket (not shown) configured to receive a connector on another end. This allows several linear lamps 1300 to be connected in series to cover a desired area. Individual linear lamps 1300 may range from 1 foot to 6 feet in length.

The body 1301 functions as a heat sink and dissipates heat generated by the light emitting packages 201. To increase heat radiation from the linear lamp 1300 and thereby increase cooling, the body 1301 can include a series of heat radiating fins 1302 located on the sides of the body 1301. To further increase heat radiation from the linear lamp 1300, the outer surface of the body 1301 can be treated to increase its emissivity such as for example painted black or anodized.

Light emitting packages 201, such as the ones described above in FIG. 2A, may be mounted on a rectangular shaped MCPCB 1305. A first wavelength conversion component comprising first photo-luminescent material is located within a cavity of each light emitting package 201 and configured to encapsulate the light emitters within the light emitting package 201. The under surface of the MCPCB 1305 sits in thermal contact with a second recessed channel 1306 that includes inclined walls 1308.

A generally hemi-spherical elongated second wavelength conversion component 1311 may be positioned remote to the light emitting packages 201. The second wavelength conversion component 1311 may be secured within the second recessed channel 1306 by sliding the wavelength conversion component 1311 under the inclined walls 1308 such that the wavelength conversion component 1311 engages with the inclined walls 1308. Alternatively, the second wavelength conversion component 1311 may be flexibly placed under the inclined walls 1308 such that the second wavelength conversion component 1311 engages with the inclined walls 1308.

The second wavelength conversion component 1311 may comprise a phosphor material embedded within a carrier material without the addition of a light transmissive substrate, such as the one described above in FIG. 2B. The first wavelength conversion component is closer in proximity to the light emitters and smaller in size than the second wavelength conversion component 1311.

As discussed above, utilizing a first wavelength conversion component that is closer in proximity to the light emitters and smaller in size than a second wavelength conversion component, reduces overall costs of the linear lamp 1300. Reducing the area of the first wavelength conversion component enables a total amount of the first photo-luminescent material to be reduced. Additionally, placing the first wavelength conversion component in closer proximity to the light emitters allows the linear lamp 1300 to generate a final emission product with a required amount of light of a color generated by the first wavelength conversion component whilst reducing the amount of photo-luminescent material needed to achieve the desired amount. Furthermore, the light emitting device may maintain a more pale yellow exterior appearance when red phosphor is included in the first wavelength conversion component and yellow and green phosphor is included in the second wavelength conversion component as discussed above, which may be more aesthetically pleasing to some users. In some embodiments, the addition of a light diffusing layer to the second wavelength conversion component provides the benefit of further improving the visual appearance of the light emitting device in an off-state by further reducing the yellow external appearance, as described above.

In alternative embodiments, the wavelength conversion component of the linear lamp may be configured in the shape of a generally planar strip. In such embodiments, it will be appreciated that the second recessed channel may instead have vertical walls that extend to allow the wavelength conversion component to be received by the second recessed channel.

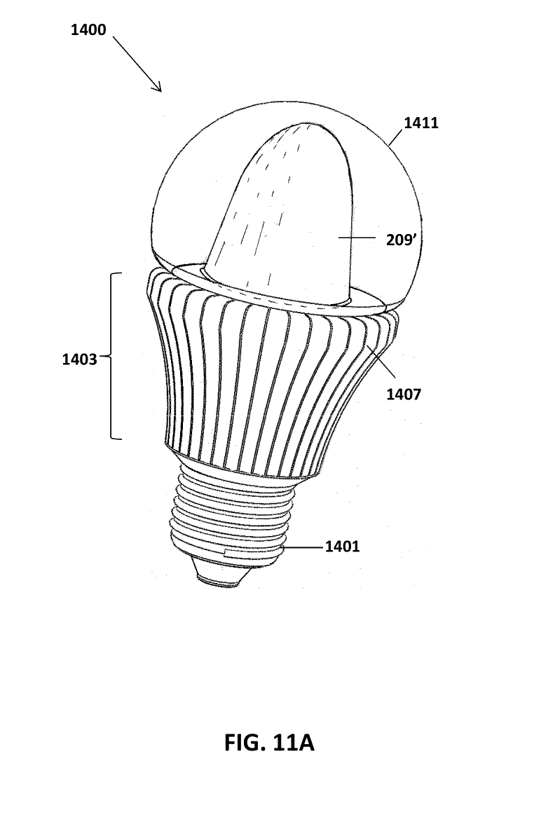

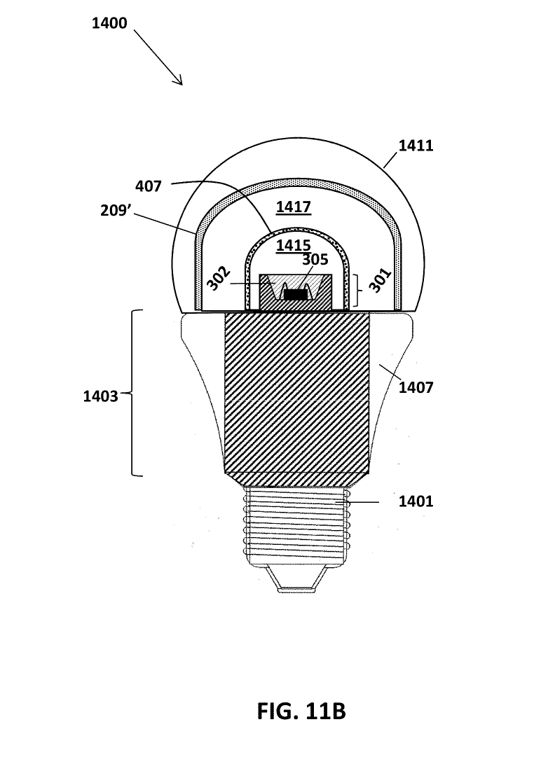

FIGS. 11A and 11B illustrate a perspective view and a cross-sectional view of an application of a light emitting device in accordance with some embodiments. FIGS. 11A and 11B illustrate an LED light bulb 1400. The LED light bulb 1400 is intended to be used as an energy efficient replacement for a conventional incandescent or fluorescent light bulb. The light bulb 1400 comprises a screw base 1401 that is configured to fit within standard light bulb sockets, e.g. implemented as a standard Edison screw base.

The light bulb 1400 may further comprise a thermally conductive body 1403 fabricated from, for example, die cast aluminum. The body functions as a heat sink and dissipates heat generated by the light emitting package 301. To increase heat radiation from the light bulb 1400 and thereby increase cooling of the light bulb 1400, the body 1403 can include a series of latitudinal radially extending heat radiating fins 1407. To further increase the radiation of heat, the outer surface of the body 1403 can be treated to increase its emissivity such as for example painted black or anodized.

The light bulb 1400 may comprise a light emitting package 301, such as the one described above in FIG. 3A, in thermal contact with the body 1403. Light emitters 305 may be located within a cavity of the light emitting package 301 with a light transmissive encapsulation 302 covering the light emitter 305. The first wavelength conversion component 407 is located remotely to the light emitters 305. The first wavelength conversion component 407 has a three-dimensional shape (e.g., elongated dome shaped and/or ellipsoidal shell) that forms an enclosure that encloses the light emitting package 301. The three dimensional first wavelength conversion component 407 may comprise a phosphor material embedded within a carrier material without the addition of a light transmissive substrate.

The light bulb 1400 further comprises a second wavelength conversion component 209′, such as the one described above in FIG. 2B, having a three-dimensional shape (e.g., elongated dome shaped and/or ellipsoidal shell) that encloses the light emitting package 201 as well as the first wavelength conversion component 407. The three dimensional second wavelength conversion component 209′ may comprise a phosphor material embedded within a carrier material without the addition of a light transmissive substrate. The first wavelength conversion component 407 is closer in proximity to the light emitters 305 and smaller in size than the second wavelength conversion component 209′.

As discussed above, utilizing a first wavelength conversion component that is closer in proximity to the light emitters and smaller in size than a second wavelength conversion component, reduces overall costs of the light bulb 1400. Reducing the area of the first wavelength conversion component enables a total amount of the first photo-luminescent material to be reduced. Additionally, placing the first wavelength conversion component in closer proximity to the light emitters allows the linear lamp 1400 to generate a final emission product with a required amount of light of a color generated by the first wavelength conversion component whilst reducing the amount of photo-luminescent material needed to achieve the desired amount. Furthermore, the light emitting device may maintain a more pale yellow exterior appearance when red phosphor is included in the first wavelength conversion component and yellow and green phosphor is included in the second wavelength conversion component as discussed above, which may be more aesthetically pleasing to some users. In some embodiments, the addition of a light diffusing layer to the second wavelength conversion component provides the benefit of further improving the visual appearance of the light emitting device in an off-state by further reducing the yellow external appearance, as described above.

An envelope 1411 may extend around the upper portion of the LED light bulb 1400, enclosing the light source package 301, the first wavelength conversion component 407 and the second wavelength conversion component 209′. The envelope 1411 is a light-transmissive material (e.g. glass or plastic) that provides protective and/or diffusive properties for the LED light bulb 1400.

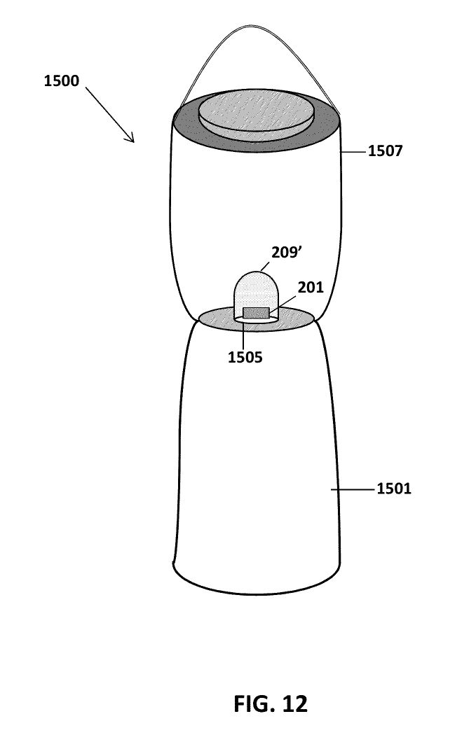

FIG. 12 illustrates a perspective of another application of a wavelength conversion component in accordance with some embodiments. FIG. 12 illustrates an LED lantern 1500. The LED lantern 1500 is intended to be used as an energy efficient replacement for conventional gas and fluorescent lanterns (e.g., camping lanterns).

The lantern 1500 comprises a generally cylindrical thermally conductive body 1501 fabricated from, for example, plastic material or pressed metal. The body 1501 further includes an internal heat sink which dissipates heat generated by the light emitters. To increase heat radiation from the lantern 1500 and thereby increase cooling of the lantern 1500, the outer surface of the body can be treated to increase its emissivity such as for example painted black or anodized.

A light emitting package 201, such as the one described above in FIG. 2A, may be mounted on an MCPCB 1505. A first wavelength conversion component comprising first photo-luminescent material is located within a cavity of the light emitting package 201 and configured to encapsulate the light emitter. The lantern 1500 also comprises a three-dimensional (e.g., elongated dome shaped and/or ellipsoidal shell) second wavelength conversion component 209′, such as the one described above in FIG. 2B, that extends from the MCPCB 1505. The first wavelength conversion component is closer in proximity to the light emitters and smaller in size than the second wavelength conversion component 209.

As discussed above, utilizing a first wavelength conversion component that is closer in proximity to the light source and smaller in size than a second wavelength conversion component, reduces overall costs of the lantern 1500. Reducing the area of the first wavelength conversion component enables a total amount of the first photo-luminescent material to be reduced. Additionally, placing the first wavelength conversion component in closer proximity to the light source allows the lantern 1500 to generate a final emission product with a required amount of light of a color generated by the first wavelength conversion component whilst reducing the amount of photo-luminescent material needed to achieve the desired amount. Furthermore, the light emitting device may maintain a more pale yellow exterior appearance when red phosphor is included in the first wavelength conversion component and yellow and green phosphor is included in the second wavelength conversion component as discussed above, which may be more aesthetically pleasing to some users. In some embodiments, the addition of a light diffusing layer to the second wavelength conversion component provides the benefit of further improving the visual appearance of the light emitting device in an off-state by further reducing the yellow external appearance, as described above.

A light transmissive cover 1507 may extend around the upper portion of the lantern, surrounding the light emitting packages 201 and the second wavelength conversion component 209′. The light transmissive cover 1507 comprises a light-transmissive material (e.g. glass or plastic) that provides protective and/or diffusive properties for the LED lantern 1500. The lantern 1500 may further comprise a lid that sits on top of the light transmissive cover 1507 to enclose the light emitting packages 201 and the second wavelength conversion component 209′.

The above applications of light emitting devices describe a remote wavelength conversion configuration, wherein at least a second wavelength conversion component is remote to one or more light emitters. The second wavelength conversion component and body of those light emitting devices define an interior volume wherein the light emitters are located. The interior volume may also be referred to as a light mixing chamber. For example, in the downlight 1000 of FIG. 7A, 7B, 7C, an interior volume 1029 is defined by the second wavelength conversion component 209, the light reflective chamber mask 1015, and the body of the downlight 1001. In the linear lamp 1300 of FIG. 10A and 10B, an interior volume 1325 is defined by the second wavelength conversion component 1311 and the body of the linear lamp 1301. In the light bulb 1400 of FIG. 11A and 11B, an interior volume 1415 is defined by the first wavelength conversion component 407 and the body of the light bulb 1403. Another interior volume 1417 is defined by the second wavelength conversion component 209′ and the body of the light bulb 1403. Such an interior volume provides a physical separation (air gap) of the wavelength conversion component from the light emitters that improves the thermal characteristics of the light emitting device. Due to the isotropic nature of photoluminescence light generation, approximately half of the light generated by the phosphor material can be emitted in a direction towards the light emitters and can end up in the light mixing chamber. It is believed that on average as little as 1 in a 10,000 interactions of a photon with a phosphor material particle results in absorption and generation of photoluminescence light. The majority, about 99.99%, of interactions of photons with a phosphor particle result in scattering of the photon. Due to the isotropic nature of the scattering process on average half the scattered photons will be in a direction back towards the light emitters. As a result up to half of the light generated by the light emitters that is not absorbed by the phosphor material can also end up back in the light mixing chamber. To maximize light emission from the device and to improve the overall efficiency of the light emitting device the interior volume of the mixing chamber includes light reflective surfaces to redirect—light in—the interior volume towards the wavelength conversion component and out of the device. The light mixing chamber may also operate to mix light within the chamber. The light mixing chamber can be defined by the wavelength conversion component in conjunction with another component of the device such a device body or housing (e.g., dome-shaped wavelength conversion component encloses light emitters located on a base of device body to define light mixing chamber, or planar wavelength conversion component placed on a chamber shaped component to enclose light emitters located on a base of device body and surrounded by the chamber shaped component to define light mixing chamber). For example, the downlight 1000 of FIGS. 7A, 7B, and 7C, includes an MCPCB 1009, on which the light emitting packages 201 are mounted, comprising light reflective material and a light reflective chamber wall mask 1015 to facilitate the redirection of light reflected back into the interior volume towards the second wavelength conversion component 209. The linear lamp 1300 of FIGS. 10A and 10B includes an MCPCB 1305, on which the light emitting packages 201 are mounted, comprising light reflective material to facilitate the redirection of light reflected back into the interior volume towards the second wavelength conversion component 1311. The light bulb 1400 of FIGS. 11A and 11B may also include an MCPCB to facilitate the redirection of light reflected back into the interior volume towards either the first wavelength conversion component 407 or the second wavelength conversion component 209′.

The above applications of light emitting devices describe only a few embodiments with which the claimed invention may be applied. It is important to note that the claimed invention may be applied to other types of light emitting device applications, including but not limited to, wall lamps, pendant lamps, chandeliers, recessed lights, track lights, accent lights, stage lighting, movie lighting, street lights, flood lights, beacon lights, security lights, traffic lights, headlamps, taillights, signs, etc.

Therefore, what has been described is a light emitting device utilizing multiple wavelength conversion components for remote wavelength conversion. By utilizing a first wavelength conversion component that is closer in proximity to the light source and smaller in size than a second wavelength conversion component, overall costs of the light emitting device may be reduced. Reducing the area of the first wavelength conversion component enables a total amount of the first photo-luminescent material to be reduced. Additionally, placing the first wavelength conversion component in closer proximity to the light source allows the light emitting device to generate a final emission product with a required amount of light of a color generated by the first wavelength conversion component whilst reducing the amount of photo-luminescent material needed to achieve the desired amount.

In the foregoing description, the invention has been described with reference to specific embodiments thereof. It will, however, be evident that various modifications and changes may be made thereto without departing from the broader spirit and scope of the invention. The specification and drawings are accordingly, to be regarded in an illustrative rather than restrictive sense.

What is claimed is:

1. A light emitting device, comprising:
a solid-state light source;
a first wavelength conversion component comprising a first photo-luminescent material;
a second wavelength conversion component comprising a second photo-luminescent material;
wherein the second wavelength conversion component is relatively more remote to the solid-state light source as compared to the first wavelength conversion component; and
wherein the first wavelength conversion component is relatively closer in proximity to the solid-state light source and smaller in area as compared to the second wavelength conversion component.

2. The light emitting device of claim 1, wherein the first wavelength conversion component is remote to the solid-state light source.

3. The light emitting device of claim 1, wherein:
the first wavelength conversion component is configured to convert light generated by the solid-state light source into light of a first wavelength, wherein an emission product of the first wavelength conversion component comprises combined light generated by the solid-state light source and the first wavelength conversion component; and
the second wavelength conversion component is configured to convert light generated by the solid-state light source into light of a second wavelength, wherein a final emission product of the light emitting device comprises combined light generated by the solid-state light source, the first wavelength conversion component, and the second wavelength conversion component.

4. The light emitting device of claim 1, wherein the solid-state light source is selected from the group consisting of: a blue light emitting LED and a U.V. light emitting LED.

5. The light emitting device of claim 1, wherein the solid-state light source is located in a package and wherein the first wavelength conversion component includes a first photo-luminescent material that is located in a light transmissive binder to encapsulate the light source.

6. The light emitting device of claim 1, wherein the second wavelength conversion encloses the solid-state light source and the first wavelength conversion component.

7. The light emitting device of claim 6, wherein the first wavelength conversion component and the second wavelength conversion component may be individually attached to a housing of the light emitting device.

8. The light emitting device of claim 1, wherein the first wavelength conversion component and the second wavelength conversion component are combined in a single entity.

9. The light emitting device of claim 8, further comprising a light transmissive medium between the first wavelength conversion component and the second wavelength conversion component, wherein the light transmissive medium is in contact with an outer surface of the first wavelength conversion component and in contact with an inner surface of the second wavelength conversion component.

10. The light emitting device of claim 1, further comprising a housing shaped as a frustum of a cone, wherein the solid-state light source is attached to a base of the housing, the first wavelength conversion component is positioned on a lower portion of a sidewall of the light emitting device housing and the second wavelength conversion component is position on an upper portion of the housing.

11. The light emitting device of claim 1, wherein the first photo-luminescent material and the second photo-luminescent material comprise a phosphor material.

12. The light emitting device of claim 1, wherein the first photo-luminescent material and the second photo-luminescent material comprise quantum dots.

13. The light emitting device of claim 1, wherein the second wavelength conversion component comprises a light transmissive substrate and a wavelength conversion layer.

14. The light emitting device of claim 13, wherein the light transmissive substrate is selected from the group consisting of: a polycarbonate, an acrylic, and a glass.

15. The light emitting device of claim 1, wherein the first wavelength conversion component has an area that is at least two times smaller than the area of the second wavelength conversion component.

16. The light emitting device of claim 1, and further comprising a light diffusing layer positioned on an outer surface of the second wavelength conversion component.

17. The light emitting device of claim 16, wherein the light diffusing layer comprises particles of material selected from the group consisting of: titanium dioxide, barium sulfate, magnesium oxide, silicon dioxide, aluminum oxide and combinations thereof.

18. The light emitting device of claim 1, wherein the light emitting device is selected from the group consisting of: downlights, light bulbs, linear lamps, lanterns, wall lamps, pendant lamps, chandeliers, recessed lights, track lights, accent lights, stage lighting, movie lighting, street lights, flood lights, beacon lights, security lights, traffic lights, headlamps, taillights, and signs.

19. The light emitting device of claim 1, wherein the second wavelength conversion component further comprises a light diffusing layer comprising particles of a light scattering material.

20. The light emitting device of claim 19, wherein the light diffusing layer comprises a mixture of the light scattering material and a light transmissive carrier material.

21. The light emitting device of claim 19, wherein the light scattering material is selected from the group consisting of: titanium dioxide, barium sulfate, magnesium oxide, silicon dioxide and aluminum oxide.

22. The light emitting device of claim 19, wherein the light diffusing layer comprises planar shapes.

23. The light emitting device of claim 19, wherein the light diffusing layer comprises a three dimensional shape.

24. The light emitting device of claim 19, wherein the light scattering material within the light diffusing layer improves an OFF state white appearance of the light emitting device.

25. A linear lamp comprising:
an elongate housing;
a plurality of solid-state light emitters housed within the housing and configured along the length of the housing;
a first wavelength conversion component comprising a first photo-luminescent material;
an elongate second wavelength conversion component comprising a second photo-luminescent material, the second wavelength conversion component being remote to the plurality of solid-state light emitters and configured to in part at least define a light mixing chamber,
wherein the second wavelength conversion component is relatively more remote to the plurality of solid-state light emitters as compared to the first wavelength conversion component; and
wherein the first wavelength conversion component is relatively closer in proximity to the plurality of solid-state light emitters and smaller in area as compared to the second wavelength conversion component.

26. A downlight comprising:
a body comprising one or more solid-state light emitters, wherein the body is configured to be positioned within a downlighting fixture such that the downlight emits light in a downward direction;
a first wavelength conversion component comprising a first photo-luminescent material;
a second wavelength conversion component comprising a second photo-luminescent material, the second wavelength conversion component being remote to the one or more solid-state light emitters and configured to in part at least define a light mixing chamber;
wherein the second wavelength conversion component is relatively more remote to the one or more solid-state light emitters as compared to the first wavelength conversion component; and
wherein the first wavelength conversion component is relatively closer in proximity to the one or more solid-state light emitters and smaller in area as compared to the second wavelength conversion component.

27. A light bulb comprising:
a connector base configured to be inserted in a socket to form an electrical connection for the light bulb;
a body comprising one or more solid-state light emitters;
a first wavelength conversion component comprising a first photo-luminescent material;
a second wavelength conversion component comprising a second photo-luminescent material and having a three dimensional shape, the second wavelength conversion component being remote to the one or more solid-state light emitters and configured to enclose the one or more solid-state light emitters to in part at least define a light mixing chamber;
wherein the second wavelength conversion component is relatively more remote to the one or more solid-state light emitters as compared to the first wavelength conversion component; and
wherein the first wavelength conversion component is relatively closer in proximity to the one or more solid-state light emitters and smaller in area as compared to the second wavelength conversion component.
